(19) United States
(12) Patent Application Publication
(10) Pub. No.: US 2025/0001661 A1
(43) Pub. Date: Jan. 2, 2025

(54) SYSTEM AND METHOD FOR MONITORING INJECTION MOLDING

(71) Applicant: SYBRIDGE TECHNOLOGIES U.S.INC., Southfield, MI (US)

(72) Inventors: J. Louie MENESES, Windsor (CA); Davide MARTINO, Tecumseh (CA); Jonathan Robert ST. PIERRE, Windsor (CA)

(21) Appl. No.: 18/708,966

(22) PCT Filed: Nov. 10, 2022
(86) PCT No.: PCT/US2022/049539

§ 371 Date: May 9, 2024

Related U.S. Application Data
(60) Provisional application No. 63/277,971, filed on Nov. 10, 2021.

(51) Int. Cl. B29C 45/76; B29C 37/00; B29C 45/77; B29C 45/78

(52) U.S. Cl. CPC B29C 45/768; B29C 45/77; B29C 45/78; B29C 2037/903

(57) ABSTRACT

System and methods for monitoring an injection molding process are disclosed. A monitoring system for monitoring operation of an injection mold during an injection molding process, may include a sensor system configured for integration into the injection mold, the sensor system may be configured to obtain, from the injection mold, operational data associated with the injection molding process, and may further contain a computing system in communication with the sensor system, the computing system may be configured to: receive, from the sensor system, the operational data; monitor a process parameter of the injection molding process based on analyzing the operational data with respect to a predictive model of the process parameter, and generate, based on monitoring the process parameter, an output for transmitting to an electronic device in communication with the computing system to provide a monitoring status indication.

### CROSS REFERENCE TO RELATED APPLICATIONS

This application claims the benefit of priority of U.S. provisional patent application No. 63/277,971, filed Nov. 10, 2021, the contents of which are hereby incorporated by reference.

### FIELD

The present disclosure relates to injection molding processes, including but not limited to systems, computing platforms, methods, and storage media for automating monitoring of injection molding processes.

### BACKGROUND

Injection molding is a manufacturing technique often used to manufacture parts in high volume. The process generally involves using an injection molding press to inject molten material into an injection mold configured to receive the molten material for forming into a part defined by the shape and design of the mold.

Once the injection mold is filled, a holding pressure is maintained while the molten material cools and hardens into a part formed by the shape of cavities of the injection mold. Once the molten material cools sufficiently, the mold is opened and the part is separated from the mold.

It remains desirable however to develop further improvements and advancements in relation to injection molds and injection molding processes, to overcome shortcomings of known techniques, and to provide additional advantages.

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

### SUMMARY

One aspect of the present disclosure relates to a monitoring system for monitoring operation of an injection mold during an injection molding process. The system may include a sensor system configured for integration into the injection mold, the sensor system may be configured to obtain, from the injection mold, operational data associated with the injection molding process, and may further contain a computing system in communication with the sensor system, the computing system may be configured to: receive, from the sensor system, the operational data; monitor a process parameter of the injection molding process based on analyzing the operational data with respect to a predictive model of the process parameter, and generate, based on monitoring the process parameter, an output for transmitting to an electronic device in communication with the computing system to provide a monitoring status indication.

Another aspect of the present disclosure relates to a method for monitoring operation of an injection mold during an injection molding process. The method may include: receiving, from a sensor system integrated into the injection mold, operational data associated with the injection molding process; monitoring a process parameter of the injection molding process based on analyzing the operational data with respect to a predictive model of the process parameter, and generating, based on the monitoring of the process parameter, an output for transmitting to an electronic device in communication with the computing system to provide a monitoring status indication. In an example embodiment, the present disclosure provides a non-transient computer-readable storage medium having instructions embodied thereon. The instructions may be executable by one or more processors to perform a method of monitoring an injection molding process as described and illustrated herein.

### BRIEF DESCRIPTION OF THE DRAWINGS

Embodiments of the present disclosure will now be described, by way of example only, with reference to the attached Figures.

FIG. 1 illustrates a block diagram of a system for monitoring an injection molding process for an injection mold, in accordance with one or more embodiments.

FIG. 2A is a perspective view of a first side of a sensor system, in accordance with one or more embodiments.

FIG. 2B is a perspective view of a second side of the sensor system depicted in FIG. 2A.

FIG. 2C is top view of the first side of the sensor system depicted in FIG. 2A.

FIG. 2D is a side elevation view of the sensor system depicted in FIG. 2C.

FIG. 3 illustrates a method for monitoring an injection molding process, in accordance with one or more embodiments.

FIG. 4 is a block diagram of an example computing device or system for implementing a system and/or method for monitoring an injection molding process, in accordance with one or more embodiments.

Throughout the drawings, sometimes only one or fewer than all of the instances of an element visible in the view are designated by a lead line and reference character, for the sake only of simplicity and to avoid clutter. It will be understood, however, that in such cases, in accordance with the corresponding description, that all other instances are likewise designated and encompasses by the corresponding description.

### DETAILED DESCRIPTION

The following are examples of systems and methods for monitoring an injection molding process in accordance with the present disclosure.

According to an aspect, the present disclosure provides a monitoring system for monitoring operation of an injection mold during an injection molding process, the monitoring system comprising a sensor system configured for integration into the injection mold, the sensor system configured to obtain, from the injection mold, operational data associated with the injection molding process, and a computing system in communication with the sensor system, the computing system being configured to: receive, from the sensor system, the operational data; monitor a process parameter of the injection molding process based on analyzing the operational data with respect to a predictive model of the process parameter, and generate, based on monitoring the process parameter, an output for transmitting to an electronic device in communication with the computing system to provide a monitoring status indication.

According to an example embodiment, the sensor system comprises an injection mold pressure sensor configured to generate pressure data wherein the operational data comprises the pressure data.

According to an example embodiment, the predictive model is based on a mold flow analysis of the injection mold and the injection molding process, and the process parameter is an expected injection mold pressure.

According to an example embodiment, the analysis of the operational data, based on the predictive model, indicates the pressure data from the injection mold pressure sensor is lower than the expected injection mold pressure and the output is an indication of low injection mold pressure at the injection mold pressure sensor.

According to an example embodiment, the analysis of the operational data, based on the predictive model, indicates the pressure data from the injection mold pressure sensor is higher than the expected injection mold pressure and the output is an indication of high injection mold pressure at the injection mold pressure sensor.

According to an example embodiment, the sensor system comprises a first injection mold pressure sensor configured for displacement proximal to an input end of an injection pore of the injection mold, and a second injection mold pressure sensor configured for displacement proximal to an output end of the injection pore of the injection mold.

According to an example embodiment, the first injection mold pressure sensor is configured to generate first pressure data; the second injection mold pressure sensor is configured to generate second pressure data, and the operational data obtained by the sensor system comprises the first sensor data and the second sensor data.

According to an example embodiment, the predictive model is based on a mold flow analysis of the injection molding process for the injection mold, and the process parameter is an expected injection mold pressure.

According to an example embodiment, the analysis of the operational data, based on the predictive model, indicates the first pressure data from the first injection mold pressure sensor or the second pressure data from the second injection mold pressure sensor is lower than the expected injection mold pressure, and the output is an indication of low injection mold pressure at at least one of the first injection mold pressure sensor or the second injection mold pressure sensor.

According to an example embodiment, the analysis of the operational data, based on the predictive model, indicates the first pressure data from the first injection mold pressure sensor or the second pressure data from the second injection mold pressure sensor is higher than the expected injection mold pressure, and the output is an indication of high injection mold pressure at at least one of the first injection mold pressure sensor or the second injection mold pressure sensor.

According to an example embodiment, the sensor system comprises an injection mold temperature sensor configured for displacement at a sensor location within the injection mold and for generating temperature data, wherein the operational data of the sensor system comprises the temperature data.

According to an example embodiment, the predictive model is based on a mold flow analysis of the injection molding process for the injection mold, and the process parameter is an expected internal temperature of the injection mold.

According to an example embodiment, the analysis of the operational data, based on the predictive model, indicates the temperature data from the injection mold temperature sensor is lower than the expected internal temperature of the injection mold, and the output is an indication of a lower than expected temperature at the sensor location.

According to an example embodiment, the analysis of the operational data, based on the predictive model, indicates the temperature data from the injection mold temperature sensor is higher than the expected internal temperature of the injection mold, and the output is an indication of a higher than expected temperature at the sensor location.

According to an example embodiment, the sensor system comprises a water temperature sensor configured for displacement proximal to a water line of the injection mold and for generating water line temperature data, wherein the operational data of the sensor system comprises the water line temperature data.

According to an example embodiment, the predictive model is based on a mold flow analysis of the injection molding process for the injection mold, and the process parameter is an expected water line temperature of the water line.

According to an example embodiment, the analysis of the operational data, based on the predictive model, indicates the water line temperature data is lower than the expected water line temperature of the water line, and the output is an indication of a lower than expected water line temperature.

According to an example embodiment, the analysis of the operational data, based on the predictive model, indicates the water line temperature data is higher than the expected water line temperature of the water line, and the output is an indication of a higher than expected water line temperature.

According to an example embodiment, the sensor system comprises at least one of a water line temperature sensor, a water line pressure sensor, an injection mold temperature sensor, an injection mold pressure sensor, a strain sensor, a deflection sensor, or a crash detection sensor.

According to an example embodiment, the process parameter comprises one of: an internal pressure of the injection mold, a temperature of the injection mold, a deflection of the injection mold, a strain of the injection mold, a cooling system temperature, a cooling system flow rate, a cooling system pressure, or a crash detection indicator.

According to an example embodiment, the predictive model comprises one of: a mold flow analysis of the process parameter, a Finite Element Analysis (FEA) of the process parameter, or a tool design of the process parameter.

According to an example embodiment, the computing system is a cloud computing system.

According to an example embodiment, the monitoring system further includes transmitting the generated output based on an indication that the monitored process parameter is outside of an expected operational range associated with the predictive model.

According to an aspect, the present disclosure provides a monitoring system for integrating into an injection mold and for monitoring operation of an injection molding process during use of the injection mold, the monitoring system comprising a sensor system configured to obtain, from the injection mold, operational data associated with the injection molding process, and a computing system in communication with the sensor system, the computing system being configured to receive, from the sensor system, the operational data; monitor a process parameter of the injection molding process based on analyzing the operational data with respect to a predictive model of the process parameter, and generate, based on monitoring the process parameter, an output for transmitting to an electronic device in communication with the computing system to provide a monitoring status indication.

According to an aspect, the present disclosure provides a monitored injection molding system for performing an injection molding process, comprising an injection mold configured to receive molten material from an injection molding press; a sensor system integrated into the injection mold and configured to obtain, from the injection mold, operational data associated with the injection molding process, and a computing system in communication with the sensor system, the computing system being configured to receive, from the sensor system, the operational data; monitor a process parameter of the injection molding process based on analyzing the operational data with respect to a predictive model of the process parameter, and generate, based on monitoring the process parameter, an output for transmitting to an electronic device in communication with the computing system to provide a monitoring status indication.

According to an aspect, the present disclosure provides a non-transitory computer-readable storage medium having instructions stored thereon, that when executed by a processor, perform a computer-implemented method for monitoring an injection molding process for an injection mold, the method comprising receiving, from a sensor system integrated into the injection mold, operational data associated with the injection molding process; monitoring a process parameter of the injection molding process based on analyzing the operational data with respect to a predictive model of the process parameter, and generating, based on the monitoring of the process parameter, an output for transmitting to an electronic device in communication with the computing system to provide a monitoring status indication.

According to an aspect, the present disclosure provides a method for monitoring operation of an injection mold during an injection molding process, comprising generating, from a sensor system integrated into the injection mold, operational data associated with the injection molding process; receiving the operational data, from the sensor system, at a computing system in communication with the sensor system; monitoring, at the computing system, a process parameter associated with the injection molding process based on analyzing the operational data with respect to a predictive model of the process parameter; generating, based on the monitoring of the process parameter, an output having a monitoring status indication, and transmitting the output to an electronic device in communication with the computing system.

According to an example embodiment, the predictive model is based on a mold flow analysis of the injection molding process for the injection mold, and the process parameter is an expected injection mold pressure.

According to an example embodiment, the method may include generating pressure data at an injection mold pressure sensor displaced within the injection mold; wherein the sensor system includes the injection mold pressure sensor, and wherein the operational data includes the pressure data.

According to an example embodiment, the method may include detecting, based on the monitoring of the process parameter, the pressure data being less than the expected injection mold pressure, and generating the output to include an indication of low injection mold pressure.

According to an example embodiment, the method may include detecting, based on the monitoring of the process parameter, the pressure data being higher than the expected injection mold pressure, and generating the output to include an indication of high injection mold pressure.

According to an example embodiment, the method may include generating first pressure data at a first injection mold pressure sensor displaced proximal to an input end of an injection pore of the injection mold, and generating second pressure data at a second injection mold pressure sensor displaced proximal to an output end of an injection pore of the injection mold; wherein the sensor system includes the first and second injection mold pressure sensors, and wherein the operational data includes the first and second pressure data.

According to an example embodiment, the method may include detecting, based on the monitoring of the process parameter, the first and/or second pressure data being less than the expected injection mold pressure, and generating the output to include an indication of low injection mold pressure at the first and/or second injection mold pressure sensor.

According to an example embodiment, the method may include detecting, based on the monitoring of the process parameter, the first and/or second pressure data being higher than the expected injection mold pressure, and generating the output to include an indication of high injection mold pressure at the first and/or second injection mold pressure sensor.

According to an example embodiment, the predictive model is based on a mold flow analysis of the injection molding process for the injection mold, and the process parameter is an expected internal temperature of the injection mold.

According to an example embodiment, the method may include generating temperature data at a temperature sensor displaced at a sensor location within the injection mold; wherein the sensor system includes the temperature sensor, and wherein the operational data includes the temperature data.

According to an example embodiment, the method may include detecting, based on the monitoring of the process parameter, the temperature data being less than the expected internal temperature of the injection mold, and generating the output to include an indication of low internal injection mold temperature at the sensor location.

According to an example embodiment, the method may include detecting, based on the monitoring of the process parameter, the temperature data being greater than the expected internal temperature of the injection mold, and generating the output to include an indication of high internal injection mold temperature at the sensor location.

According to an example embodiment, the predictive model is based on a mold flow analysis of the injection molding process for the injection mold, and the process parameter is an expected water line temperature of the water line.

According to an example embodiment, the method may include generating water line temperature data at a water temperature sensor displaced proximal to a water line of the injection mold; wherein the sensor system includes the water temperature sensor, and wherein the operational data includes the water line temperature data.

According to an example embodiment, the method may include detecting, based on the monitoring of the process parameter, the water line temperature data being less than the expected water line temperature of the water line, and generating the output to include an indication of lower than expected water line temperature in the water line.

According to an example embodiment, the method may include detecting, based on the monitoring of the process parameter, the water line temperature data being higher than the expected water line temperature of the water line, and generating the output to include an indication of higher than expected water line temperature in the water line.

According to an example embodiment, the sensor system comprises at least one of a water line temperature sensor, a water line pressure sensor, an injection mold temperature sensor, an injection mold pressure sensor, a strain sensor, a deflection sensor, or a crash detection sensor.

According to an example embodiment, the process parameter comprises at least one of: an internal pressure of the injection mold, a temperature of the injection mold, a deflection of the injection mold, a strain of the injection mold, a cooling system temperature, a cooling system flow rate, a cooling system pressure, or a crash detection indicator.

According to an example embodiment, the predictive model comprises one of: a mold flow analysis of the process parameter, a Finite Element Analysis (FEA) of the process parameter, or a tool design of the process parameter.

According to an example embodiment, the computing system comprises a cloud computing system.

According to an aspect, the present disclosure provides a non-transitory computer-readable storage medium having instructions stored thereon, that when executed by a processor, perform the method for monitoring operation of an injection mold during an injection molding process according to an aspect or example embodiment as disclosed herein.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

System and methods for monitoring an injection molding process are disclosed, such as monitoring an injection molding process involving an injection mold configured to receive molten material from an injection mold press for use in forming a part in accordance with the design of the injection mold. A monitoring system for monitoring operation of an injection mold during an injection molding process may include a sensor system configured for integration into the injection mold. The sensor system may be configured to obtain, from the injection mold, operational data associated with the injection molding process, and may further contain a computing system in communication with the sensor system. The computing system may be configured to: receive, from the sensor system, the operational data; monitor a process parameter of the injection molding process based on analyzing the operational data with respect to a predictive model of the process parameter, and generate, based on monitoring the process parameter, an output for transmitting to an electronic device in communication with the computing system to provide a monitoring status indication.

One known approach for monitoring an injection molding process includes incorporating sensors into an injection mold press. However, localizing sensors on the press may not provide accurate measurements and readings with respect to behavior inside an injection mold, similar to how a thermostat may not provide accurate measurements in a room farther away from the thermostat.

Advantageously, embodiments in accordance with the present disclosure incorporate sensors into the injection mold itself to provide greater accuracy and improved data collection. One or more sensors can be disposed strategically in, or on, the injection mold to generate data for use in monitoring a process parameter of an injection molding process. Sensors for integrating into the injection mold may include, but are not limited to a cooling system temperature sensor, a cooling system pressure sensor, a cooling system flow sensor, an injection mold temperature sensor, an injection mold pressure sensor, a strain sensor, a deflection sensor, or a crash detection sensor. For example, cooling system temperature sensors and/or pressure sensors may be disposed about various locations along a cooling system line of an injection mold, for respectively monitoring a temperature of a cooling medium passing through the injection mold or a pressure of the medium passing through the injection mold. Advantageously, integrating sensors into the injection mold also improves modularity, as injection molds may be configured for interchangeability with different injection mold presses and/or manufacturers, thereby removing the need to reconfigure or adapt the manufacturer's injection mold press to incorporate new or different sensors for monitoring an injection mold and the injection molding process within.

The sensor data obtained from the injection mold may be analyzed to monitor and assess a process parameter associated with an injection molding process. Process parameters may include, but are not limited to: an internal pressure of the injection mold, a temperature of the injection mold, a deflection of the injection mold, a strain of the injection mold, a cooling system temperature such as the temperature of water or other medium passing in and out of a cooling line of the injection mold, a cooling system flow rate such as the flow rate of water or other medium passing in and out of a cooling line of the injection mold, and a crash detection indicator. For example, pressure sensors may be disposed at various locations within the injection mold to generate operational data for use in assessing a pressure within the injection mold. The assessment may be accomplished, for example, by comparing the sensor data to a predictive model of a process parameter to identify expected behavior within the injection mold. For example, mold flow analysis may be leveraged to model an acceptable range of pressures within the injection mold, temperatures of the injection mold, and cooling system temperatures, flow rate, and pressure, at various timings and locations within the injection mold. The sensor data may be assessed against the predictive model, to monitor whether process parameters relating to the injection molding process are operating as expected. Furthermore, data generated and collected from the sensors may be further leveraged to identify expected failures or predict when maintenance may be required.

Compared to known approaches, embodiments of the present disclosure may provide improved data collection, improve predictions for faults or required maintenance, real-time alerts, and more accurate projections as to performance for an injection molding process.

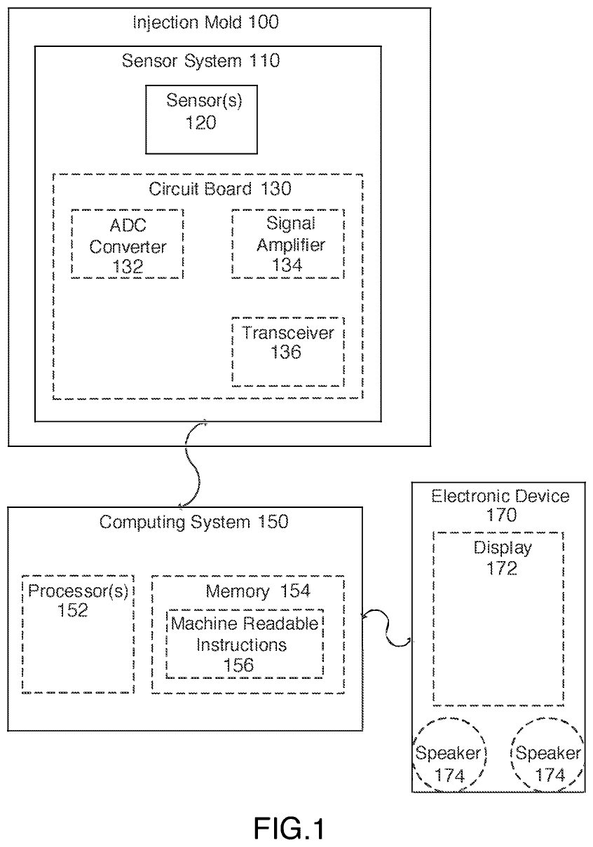

FIG. 1 illustrates a block diagram of an injection mold 100 for use in an injection molding process in accordance with an embodiment of the present disclosure. The injection mold 100 includes a sensor system 110 having one or more sensor(s) 120 integrated into the injection mold 100. The sensor(s) 120 may include, but are not limited to one or more of: injection mold temperature sensors, injection mold pressure sensors, cooling system flow sensors, cooling system temperature sensors, injection mold strain sensors, injection mold deflection sensors, injection mold crash detection sensors, POSIC™ linear sensors, and/or other sensors configured to generate data associated with the operation of the injection mold 100. One or more sensor(s) 120 may be distributed throughout the injection mold 100 to generate data associated with the injection mold and/or injection molding process.

For example, the sensor(s) 120 may comprise a plurality of pressure sensors for use in generating operational data associated with an injection molding process. For example, the sensor(s) 120 may comprise a first pressure sensor disposed at an input end of an injection pore of the injection mold 100, for generating first pressure data; and, a second pressure sensor disposed at an output end of the injection pore, for generating second pressure data. The first and second pressure data thus provide operational data associated with a pressure of the injection mold at a location where molten material passes through an injection pore and into the injection mold 100, and thus may be used to monitor a process parameter such as an internal pressure of the injection mold at the injection pore. For example, the sensor system 110 may transmit the first and second pressure data to a computing system 150 in communication with the sensor system 110 for further analysis and use in monitoring an internal pressure of the injection mold during the injection molding process.

In an embodiment, the sensor(s) 120 may include one or more cooling system flow sensors and/or cooling system temperature sensors disposed about one or more locations of a cooling system of the injection mold 100, for use in generating data indicative of flow and/or temperature, respectively, of a cooling medium such as water in the cooling line of the injection mold 100.

In an embodiment, the sensor(s) 120 may include one or more temperature sensors disposed at one or more locations within the injection mold 100, for use in generating data indicative of a temperature of the injection mold at the corresponding location of the temperature sensor within the injection mold 100.

In an embodiment, the sensor(s) 120 may include at least one of a cooling line temperature sensor, a cooling line pressure sensor, a cooling system flow sensor, an injection mold temperature sensor, an injection mold pressure sensor, a strain sensor, a deflection sensor, or a crash detection sensor. In an embodiment, the sensor(s) 120 may include a plurality of sensors selected from among these listed sensors, or other sensors.

In the example embodiment illustrated in FIG. 1, the sensor system 110 may further include a circuit board 130 having an analog-to-digital converter (ADC) 132, signal amplifier 134, and transceiver 134. In an embodiment, the sensor(s) 120 are analog sensors in communication with the ADC converter 132 which converts the analog sensor outputs into digital outputs. The digital output of the ADC converter 132 may be further amplified using the signal amplifier 134, and transmitted wirelessly to another device communicatively coupled to the transceiver 136, such as to the computing system 150. In an embodiment, the sensor(s) 120 directly transmit data to the computing system 150.

In the example embodiment illustrated in FIG. 1, the sensor system 110 may transmit data generated by the sensor(s) 120 to a computer system 150 in communication with the sensor system 110. In an embodiment, the sensor(s) 120 may be configured to transmit data directly to the computing system. In an embodiment, the sensor system 110 may include a transceiver in communication with the sensor(s) 120, the transceiver configured to transmit the sensor data to the computing system 150. In an embodiment, the computing system 150 is a cloud computing network. The computing system 150 may include one or more processor(s) 152 and a memory 154, such as or one or more machine-readable memories, storing machine-readable instructions 156 for execution by the processor(s) 152 for use analyzing sensor data and monitoring process parameters of an injection molding process, such as for example, implementing machine learning and/or artificial intelligence for use in analyzing sensor data and monitoring process parameters of an injection molding process.

In the example embodiment illustrated in FIG. 1, the computing system 150 is configured to receive, from the sensor system 110, data associated with operating the injection mold, such as operational data associated with an injection molding process, as generated by the sensor(s) 120. The computing system 150 may analyze the operational data as part of monitoring the injection molding process. For example, the computing system 150 may analyze the operational data with respect to a predictive model to determine whether the injection molding process is proceeding as expected. For example, the computing system 150 may correlate the operational data with the predictive model to determine whether a process parameter is within an acceptable range of values.

In an embodiment, the predictive model is based on a mold flow analysis of an injection mold and a corresponding injection molding process, for use in monitoring a process parameter relating to a pressure of the injection mold, a temperature of the injection mold, a temperature of the cooling system, a flow rate of the cooling system, and/or a pressure of the cooling system. In an embodiment, the predictive model is based on a Finite Element Analysis (FEA) of an injection mold and a corresponding injection molding process, for use in monitoring a process parameter relating to an injection mold deflection or an injection mold strain. In an embodiment, the predictive model is based on a tool design of the injection mold, for use in predicting and/or detecting a collision or crash during the injection molding process. Accordingly, the computing system 150 can assess the operational data received from the sensor system 110 to determine whether a process parameter of an injection molding process remains within an acceptable range of expected behavior as determined by an appropriate predictive model. In an embodiment, the acceptable range is +/−5% of the expected behavior of the process parameter as determined by the predictive model.

In an example embodiment, the computing system 150 may analyze the operational data received from the sensor system 110 to predict future maintenance for the injection mold 100. For example, the computing system 110 may correlate the operational data with a model indicative of a life span or condition of the injection mold 100, to predict when system failures may be expected to occur or when routine maintenance may be required. For example, the computing system 150 may receive data indicative of a pressure within the mold that correlates with a quality of a condition of the injection mold, thereby providing an indication of when future maintenance may be required or when failure may occur. In an embodiment, the computing system 150 may predict areas for flash (extra unwanted material at a parting line), heat distortion, part under fill, and/or overpacking. In an embodiment, modelling a life span or condition of an injection mold is based on historical repair data previously collected for the injection mold.

In the example embodiment illustrated in FIG. 1, the computing system 150 is configured to generate an output based on monitoring a process parameter of an injection molding process. In an embodiment, the output is a status indication of the injection molding process or a process parameter of the injection molding process. In an embodiment, the output is an audio signal, a visual indicator, or an electronic message. For example, the computing system 150 may be in communication with an electronic device 170, such as a smart phone having an associated display 172 and speakers 174. The computing system 150 may issue an audio output command to the electronic device 170, to play an audible noise indicative of a status of the injection molding process or a process parameter associated with the injection molding process. For example, a loud noise may indicate that a process parameter is outside of an acceptable operating range further indicating a problem with the injection mold or injection molding process.

Similarly, the computing system 150 may issue electronic messages, such as e-mails or text messages, for communication to an electronic device associated with a corresponding e-mail address or phone-number, respectively. In an embodiment, an electronic device 170 equipped with a Quick Response (QR) scanner may scan a QR code associated with an injection mold to receive status indications of an injection molding process or process parameter associated with the injection mold. In an embodiment, the computing system 150 is in communication with a database and the status indicators are provided to the database.

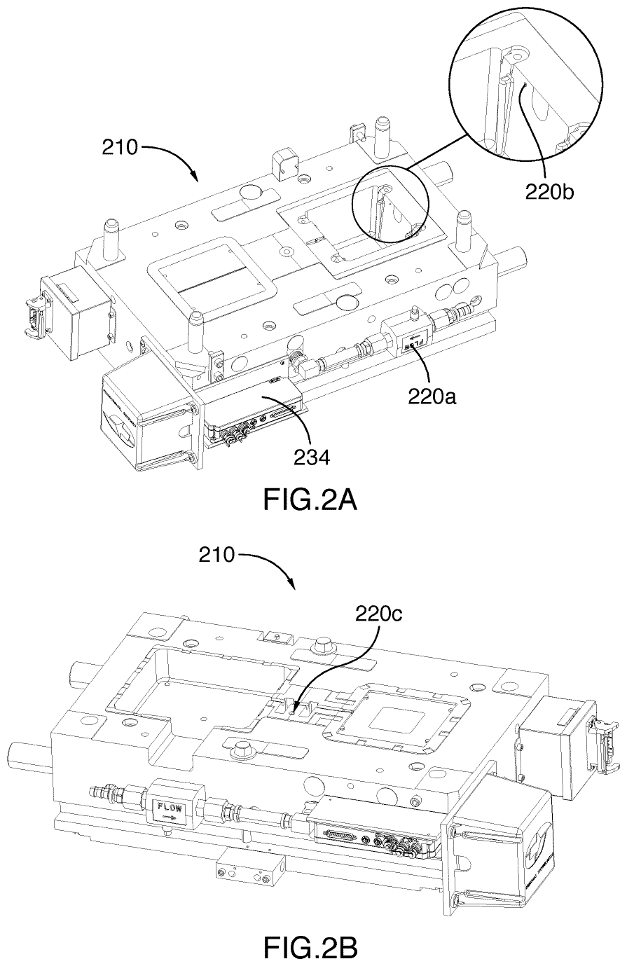

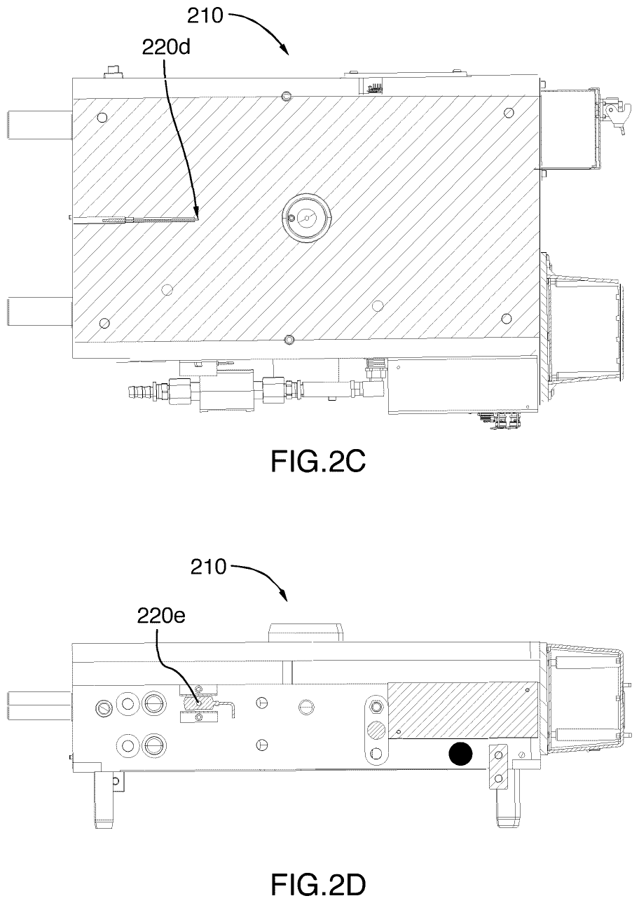

FIGS. 2A-2D illustrate different perspectives and views of a sensor system 210 in accordance with the present disclosure. The sensor system 210 may be used for example, as a sensor system 110 illustrated in FIG. 1. In this embodiment, the sensor system 210 includes a signal amplifier 234 and a plurality of sensors, including a water flow and water temperature sensor 220a, injection mold pressure sensor 220b, deflection sensor 220c, injection mold temperature sensor 220d, and injection mold strain sensor 220e. In an embodiment, the sensor system 210 is disposed at a location within an injection mold proximal to a water line and an injection mold pore. In an embodiment, the sensors are disposed in a plurality of devices and/or locations within the injection mold from one another.

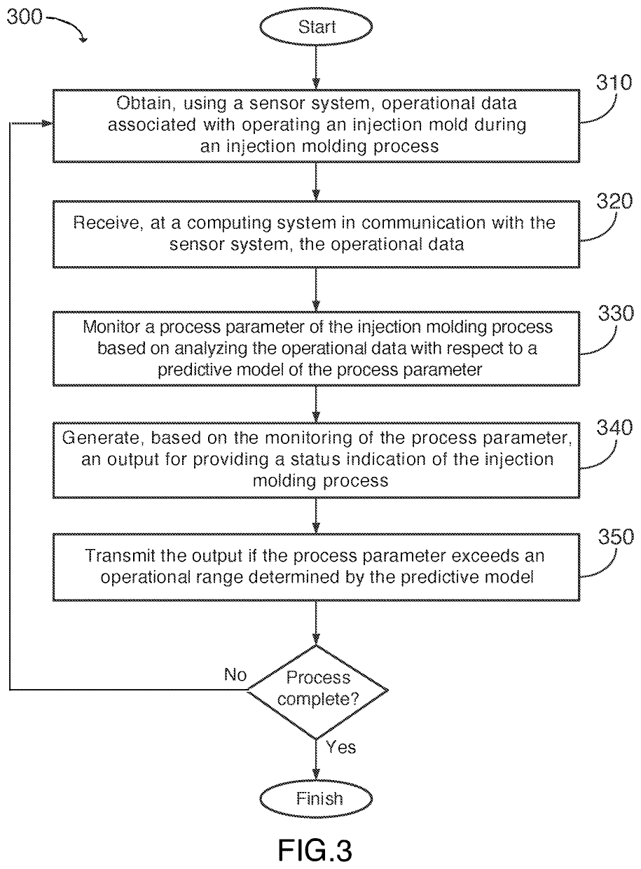

FIG. 3 illustrates a method 300 for monitoring an injection molding process in accordance with the present disclosure. The operation of method 300 is not intended to be limiting but rather illustrates an example of monitoring an injection molding process. In some embodiments, method 300 may be accomplished with one or more additional operations not described, and/or without one or more of the operations described. Similarly, the order in which the operation of method 300 is illustrated and described below is not intended to be limiting, but rather illustrative of an example of monitoring an injection molding process in accordance with the present disclosure.

In some embodiments, method 300 may be implemented in one or more processing devices (e.g., a digital processor, an analog processor, a digital circuit designed to process information, an analog circuit designed to process information, a computing network implemented in the cloud, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 310 may include obtaining, using a sensor system, operational data associated with operating an injection mold during an injection molding process. Operation 310 may be performed by one or more hardware devices, including but not limited to, sensor systems 110 and 210. Embodiments of a sensor systems may include one or more sensors in relation to generating data associated with an injection molding process; examples of sensors include, but are not limited to: temperature sensors, pressure sensors, water line temperature sensors, water line pressure sensors, injection mold temperature sensors, injection mold pressure sensors, strain sensors, deflection sensors, and crash detection sensors. Embodiments of operational data may include data generated by a sensor in accordance with the present disclosure such as temperature data and pressure data.

Operation 320 may include receiving, at a computing system in communication with the sensor system of operation 310, the operational data. Operation 320 may be performed by one or more hardware processors configured by machine-readable instructions in accordance with one or more embodiments of the present disclosure.

Operation 330 may include monitoring, at the computing system, a process parameter of the injection molding process based on analyzing the operational data with respect to a predictive model of the process parameter. Operation 330 may be performed by one or more hardware processors configured by machine-readable instructions in accordance with one or more embodiments of the present disclosure. Embodiments of a process parameter associated with an injection molding process include but are not limited to: an internal pressure of the injection mold, a temperature of the injection mold, a deflection of the injection mold, a strain of the injection mold, a cooling system temperature, a cooling system flow rate, a cooling system pressure, and a crash detection indicator. Embodiments of a predictive model in accordance with the present disclosure include, but are not limited to: a mold flow analysis of the process parameter, a Finite Element Analysis (FEA) of the process parameter, and a tool design of the process parameter.

Operation 340 may include generating, based on the monitoring of the process parameter, an output for providing a status indication of the injection molding process. Operation 340 may be performed by one or more hardware processors configured by machine-readable instructions in accordance with one or more embodiments of the present disclosure. Embodiments of an output in accordance with the present disclosure may include an indication that the injection molding process is operating at, above, or below, a particular process parameter. For example, a pressure reading at an injection pore to an injection mold may reveal that an input pressure is below an expected input pressure wherein the output may include an indication of a low input pressure.

Operation 350 may include transmitting the output, when the process parameter exceeds an operational range determined by the predictive model. Operation 350 may be performed by one or more hardware processors configured by machine-readable instructions in accordance with one or more embodiments of the present disclosure. After operation 350, the monitoring may query whether the injection molding process continues or has completed. In the event the injection molding process continues, the method 300 may repeat operations 310, 320, 330, 340, and 350. In the event that the injection molding process has completed, the method 300 may terminate.

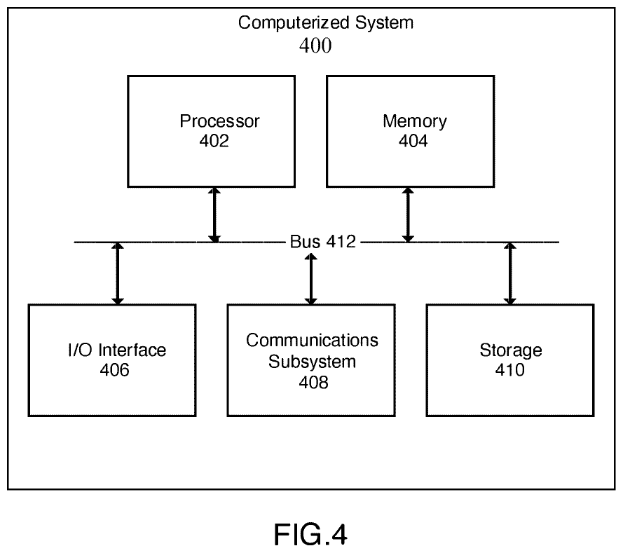

FIG. 4 is a block diagram of an example computerized device or system 400 that may be used in implementing one or more aspects or components of an embodiment of a system and method for monitoring injection molding in accordance with the present disclosure, such as may be implemented for example at least with respect to computing system 150 and/or operation of method 300.

Computerized system 400 may include one or more of a processor 402, memory 404, a mass storage device 410, an input/output (I/O) interface 406, and a communications subsystem 408. Further, system 400 may comprise multiples, for example multiple processors 402, and/or multiple memories 404, etc. Processor 402 may comprise one or more of a digital processor, an analog processor, a digital circuit designed to process information, an analog circuit designed to process information, a state machine, and/or other mechanisms for electronically processing information. These processing units may be physically located within the same device, or the processor 402 may represent processing functionality of a plurality of devices operating in coordination. The processor 402 may be configured to execute modules by software; hardware; firmware; some combination of software, hardware, and/or firmware; and/or other mechanisms for configuring processing capabilities on the processor 402, or to otherwise perform the functionality attributed to the module and may include one or more physical processors during execution of processor readable instructions, the processor readable instructions, circuitry, hardware, storage media, or any other components.

One or more of the components or subsystems of computerized system 400 may be interconnected by way of one or more buses 412 or in any other suitable manner.

The bus 412 may be one or more of any type of several bus architectures including a memory bus, storage bus, memory controller bus, peripheral bus, or the like. The CPU 402 may comprise any type of electronic data processor. The memory 404 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 410 may comprise any type of storage device configured to store data, programs, and other information and to make the data, programs, and other information accessible via the bus 412. The mass storage device 410 may comprise one or more of a solid state drive, hard disk drive, a magnetic disk drive, an optical disk drive, or the like. In some embodiments, data, programs, or other information may be stored remotely, for example in the cloud. Computerized system 400 may send or receive information to the remote storage in any suitable way, including via communications subsystem 408 over a network or other data communication medium.

The I/O interface 406 may provide interfaces for enabling wired and/or wireless communications between computerized system 400 and one or more other devices or systems. For instance, I/O interface 406 may be used to communicatively couple with sensors, such as cameras or video cameras. Furthermore, additional or fewer interfaces may be utilized. For example, one or more serial interfaces such as Universal Serial Bus (USB) (not shown) may be provided.

Computerized system 400 may be used to configure, operate, control, monitor, sense, and/or adjust devices, systems, and/or methods according to the present disclosure.

A communications subsystem 408 may be provided for one or both of transmitting and receiving signals over any form or medium of digital data communication, including a communication network. Examples of communication networks include a local area network (LAN), a wide area network (WAN), an inter-network such as the Internet, and peer-to-peer networks such as ad hoc peer-to-peer networks. Communications subsystem 408 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1394), Thunderbolt™, WiFi™ (e.g. IEEE 802.11), WiMAX (e.g. IEEE 802.16), Bluetooth™, or Near-field communications (NFC), as well as GPRS, UMTS, LTE, LTE-A, and dedicated short range communication (DSRC). Communication subsystem 408 may include one or more ports or other components (not shown) for one or more wired connections. Additionally or alternatively, communication subsystem 408 may include one or more transmitters, receivers, and/or antenna elements (none of which are shown).

Computerized system 400 of FIG. 4 is merely an example and is not meant to be limiting. Various embodiments may utilize some or all of the components shown or described. Some embodiments may use other components not shown or described but known to persons skilled in the art.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A monitoring system for monitoring operation of an injection mold during an injection molding process, the monitoring system comprising:
a sensor system configured for integration into the injection mold, the sensor system configured to obtain, from the injection mold, operational data associated with the injection molding process, and
a computing system in communication with the sensor system, the computing system being configured to:
receive, from the sensor system, the operational data;
monitor a process parameter of the injection molding process based on analyzing the operational data with respect to a predictive model of the process parameter, and
generate, based on monitoring the process parameter, an output for transmitting to an electronic device in communication with the computing system to provide a monitoring status indication.

2. The monitoring system of claim 1, wherein the sensor system comprises: an injection mold pressure sensor configured to generate pressure data wherein the operational data comprises the pressure data.

3. The monitoring system of claim 2, wherein the predictive model is based on a mold flow analysis of the injection mold and the injection molding process, and the process parameter is an expected injection mold pressure.

4-5. (canceled)

6. The monitoring system of claim 1, wherein the sensor system comprises:
a first injection mold pressure sensor configured for displacement proximal to an input end of an injection pore of the injection mold, and
a second injection mold pressure sensor configured for displacement proximal to an output end of the injection pore of the injection mold.

7. The monitoring system of claim 6, wherein:
the first injection mold pressure sensor is configured to generate first pressure data;
the second injection mold pressure sensor is configured to generate second pressure data, and
the operational data obtained by the sensor system comprises the first sensor data and the second sensor data.

8-10. (canceled)

11. The monitoring system of claim 1, wherein the sensor system comprises:
an injection mold temperature sensor configured for displacement at a sensor location within the injection mold and for generating temperature data, wherein the operational data of the sensor system comprises the temperature data.

12. The monitoring system of claim 11, wherein the predictive model is based on a mold flow analysis of the injection molding process for the injection mold, and the process parameter is an expected internal temperature of the injection mold.

13-14. (canceled)

15. The monitoring system of claim 1, wherein the sensor system comprises:
a water temperature sensor configured for displacement proximal to a water line of the injection mold and for generating water line temperature data, wherein the operational data of the sensor system comprises the water line temperature data.

16. The monitoring system of claim 15, wherein the predictive model is based on a mold flow analysis of the injection molding process for the injection mold, and the process parameter is an expected water line temperature of the water line.

17-18. (canceled)

19. The monitoring system of claim 1, wherein the sensor system comprises at least one of a water line temperature sensor, a water line pressure sensor, an injection mold temperature sensor, an injection mold pressure sensor, a strain sensor, a deflection sensor, or a crash detection sensor.

20. The monitoring system of claim 1, wherein the process parameter comprises one of: an internal pressure of the injection mold, a temperature of the injection mold, a deflection of the injection mold, a strain of the injection mold, a cooling system temperature, a cooling system flow rate, a cooling system pressure, or a crash detection indicator.

21-25. (canceled)

26. A non-transitory computer-readable storage medium having instructions stored thereon, that when executed by a processor, perform a computer-implemented method for monitoring an injection molding process for an injection mold, the method comprising:
receiving, from a sensor system integrated into the injection mold, operational data associated with the injection molding process;
monitoring a process parameter of the injection molding process based on analyzing the operational data with respect to a predictive model of the process parameter, and
generating, based on the monitoring of the process parameter, an output for transmitting to an electronic device in communication with the computing system to provide a monitoring status indication.

27. A method for monitoring operation of an injection mold during an injection molding process, comprising:
generating, from a sensor system integrated into the injection mold, operational data associated with the injection molding process;
receiving the operational data, from the sensor system, at a computing system in communication with the sensor system;
monitoring, at the computing system, a process parameter associated with the injection molding process based on analyzing the operational data with respect to a predictive model of the process parameter;
generating, based on the monitoring of the process parameter, an output having a monitoring status indication, and
transmitting the output to an electronic device in communication with the computing system.

28. The method of claim 27, wherein the predictive model is based on a mold flow analysis of the injection molding process for the injection mold, and the process parameter is an expected injection mold pressure.

29. The method of claim 28, further comprising:
generating pressure data at an injection mold pressure sensor displaced within the injection mold;
wherein the sensor system includes the injection mold pressure sensor, and wherein the operational data includes the pressure data.

30-31. (canceled)

32. The method of claim 28, further comprising:
generating first pressure data at a first injection mold pressure sensor displaced proximal to an input end of an injection pore of the injection mold, and
generating second pressure data at a second injection mold pressure sensor displaced proximal to an output end of an injection pore of the injection mold;
wherein the sensor system includes the first and second injection mold pressure sensors, and
wherein the operational data includes the first and second pressure data.

33-34. (canceled)

35. The method of claim 27, wherein the predictive model is based on a mold flow analysis of the injection molding process for the injection mold, and the process parameter is an expected internal temperature of the injection mold.

36. The method of claim 35, further comprising:
generating temperature data at a temperature sensor displaced at a sensor location within the injection mold;
wherein the sensor system includes the temperature sensor, and
wherein the operational data includes the temperature data.

37-38. (canceled)

39. The method of claim 27, wherein the predictive model is based on a mold flow analysis of the injection molding process for the injection mold, and the process parameter is an expected water line temperature of the water line.

40. The method of claim 39, further comprising:
generating water line temperature data at a water temperature sensor displaced proximal to a water line of the injection mold;
wherein the sensor system includes the water temperature sensor, and
wherein the operational data includes the water line temperature data.

41-47. (canceled)
